(19) United States
(12) Patent Application Publication
(10) Pub. No.: US 2006/0289216 A1
(43) Pub. Date: Dec. 28, 2006

(54) Relative speed computing apparatus and inter-vehicle distance control apparatus

(76) Inventor: Ryoji Kato, Tokyo (JP)

Correspondence Address: JACOBSON HOLMAN PLLC, 400 SEVENTH STREET N.W., SUITE 600, WASHINGTON, DC, 20004, US

(21) Appl. No.: 11/451,613

(22) Filed: Jun. 13, 2006

(30) Foreign Application Priority Data
Jun. 16, 2005 (JP) 2005-176961
Jun. 17, 2005 (JP) 2005-177826

(51) Int. Cl. B60T 7/16

(52) U.S. Cl. 180/169

(57) ABSTRACT

An object of the present invention is to provide a relative speed computing apparatus and inter-vehicle distance control apparatus which are capable of quickly computing an accurate relative speed agreeing with the actual situation, even in the case a wrong relative speed not agreeing with the actual situation is computed. To achieve the above object, a relative speed computing apparatus includes an inter-vehicle distance detecting section; a relative speed computing section; and a filter section for performing a filtering process on the relative speed information. The apparatus further includes a switch section. The switch section is constructed so that when a rate of change in a relative speed computation value or a rate of change in the after-filtering relative speed information is a predetermined value or greater, approximately zero is output as a relative speed. The relative speed is judged based on an output value of the switch section.

### BACKGROUND OF THE INVENTION

(1) Field of the Invention

The present invention relates to a relative speed computing apparatus for computing a relative speed between a self-vehicle and another vehicle and an inter-vehicle distance control apparatus for maintaining an inter-vehicle distance set according to a relative speed, which are suitable for an automatic cruise control apparatus for automatically traveling a vehicle at a predetermined speed.

(2) Description of the Related Art

In recent years, there have been proposed techniques for controlling vehicle travel on the basis of the inter-vehicle distance information between a self-vehicle and an object (another vehicle) in front or rear of the self-vehicle. For instance, in a technique that has been put to practical use, an automatic cruise apparatus for automatically cruising a vehicle at a preset speed has an additional function of maintaining the inter-vehicle distance between a self-vehicle and a preceding vehicle ahead of it at a predetermined distance.

In such an automatic cruise apparatus with the inter-vehicle distance control function, the presence of a preceding vehicle and the inter-vehicle distance between the self-vehicle and the preceding vehicle are sensed or detected. When no preceding vehicle is sensed, fixed-speed control is performed so that a vehicle speed set by the vehicle's driver is maintained at a set vehicle speed. When a preceding vehicle is sensed, inter-vehicle distance control is performed based on the detected inter-vehicle distance information so that the inter-vehicle distance is maintained at a predetermined distance.

In this inter-vehicle distance control, a feedback control of accelerating or decelerating a self-vehicle is performed so that the detected inter-vehicle distance becomes a target inter-vehicle distance (predetermined distance). The most simple target inter-vehicle distance is a fixed distance, but it is preferable to set a target inter-vehicle distance (predetermined distance) according to the speed of a self-vehicle. Of course, the target inter-vehicle distance becomes longer if the vehicle speed of a self-vehicle becomes higher.

In addition, there has been proposed a technique for employing the relative speed between a self-vehicle and a preceding vehicle in the above-mentioned inter-vehicle distance control (e.g., Japanese Laid-Open Patent Publication Nos. 2004-127926 and 2000-285395).

The above-mentioned Patent Publication No. 2004-127926 discloses a technique in which the vehicle speed of a self-vehicle is controlled based on the difference between the inter-vehicle distance information between the self-vehicle and a preceding vehicle and the target inter-vehicle distance information, and on the relative speed between the self-vehicle and the preceding vehicle.

Such an inter-vehicle distance control apparatus detects the inter-vehicle distance between the self-vehicle and a preceding vehicle with an inter-vehicle distance sensor such as a laser radar, a camera, etc.

Inter-vehicle distance information detected with these sensors is normally output as an analog signal such as a voltage value. However, if detected signals are employed as they are, it is difficult to perform stable control because of noise, etc. For this reason, in the electronic control unit (ECU) of a vehicle, a filtering process is performed on an inter-vehicle distance information signal input from an inter-vehicle distance sensor to the ECU to smooth the signal.

This filtering process is performed at fixed cycles (e.g., at cycles of 20 milliseconds) by a low pass filter (LPF) that is commonly used.

And the relative speed information between a self-vehicle and a preceding vehicle is computed by performing a filtering process on a signal from the inter-vehicle distance sensor and then differentiating the stable inter-vehicle distance information (after-filtering inter-vehicle distance information) with a differentiating circuit, etc.

However, since the differentiated signal value (relative speed computation value) is greatly influenced by a slight variation in the signal value (after-filtering inter-vehicle distance information) before the differentiating process, the relative speed computation value will contain noise. Because of this, the ECU performs the setting of a target inter-vehicle distance and the control of vehicle acceleration or deceleration, by again performing the filtering process on input relative speed information (relative speed computation value) to smooth the signal value and employing the stable signal value (see a bold solid line in FIG. 9).

By the way, the inter-vehicle distance sensor is not limited to particular objects (preceding and succeeding vehicles), but is used for detecting the inter-vehicle distance information between the self-vehicle and an object nearest to it in a detectable range at all times.

For example, when an interrupt vehicle appears between the self-vehicle and a preceding vehicle ahead of it, the inter-vehicle distance sensor detects the interrupt vehicle instead of the preceding vehicle and outputs the signal value of the inter-vehicle distance information between the self-vehicle and the interrupt vehicle.

As a result, the signal value of the inter-vehicle distance information output by the inter-vehicle distance sensor changes abruptly from the value of inter-vehicle distance information relative to a preceding vehicle in the absence of an interrupt vehicle to the value of inter-vehicle distance information relative to the interrupt vehicle. Such an abrupt change in inter-vehicle distance occurs when a preceding or succeeding vehicles changes a traffic lane, or when it leaves the traffic lane of the self-vehicle because of divergence, etc.

However, even in the case where inter-vehicle distance information changes abruptly when a detecting object changes, inter-vehicle distance information from the inter-vehicle distance sensor is output as a continuous signal. Because of this, when a relative speed is computed by performing a differentiating process on inter-vehicle distance information at the time of an abrupt change in the inter-vehicle distance, the computed value becomes extremely high or low. For instance, when an inter-vehicle distance detection value changes abruptly from 100 meters to 20 meters by interruption, etc., the differentiating circuit performs differentiation, assuming that the inter-vehicle distance has been reduced by 80 meters during one computation cycle (20 milliseconds). In this case, the relative speed computation value becomes an extremely large value (4000 m/s). Conversely, when the inter-vehicle distance changes abruptly from 20 meters to 100 meters, the relative speed computation value becomes an extremely low value (−4000 m/s). However, since a particular preceding vehicle has neither approached nor left, a value not agreeing with the actual situation has been computed.

Furthermore, in the case of performing a filtering process on a signal, a value computed by a low pass filter (LPF) is based on the current value and a value computed in a cycle one before the current computation cycle, so that the after-filtering signal value is cumulatively influenced by relative speed computation values obtained in each of the computation cycles before the current computation cycle. Of course, since this influence becomes greater when an after-filtering signal value is closer to the current relative speed computation value and smaller when it is an older after-filtering signal value, it converges through computation cycles, but if a value is extremely larger, convergence will require more time.

Because of this, as shown in FIG. 9, once a relative speed computation value takes an extreme value, the influence will occur over many cycles. FIG. 9 shows the case where an interrupt vehicle entered the lane of a self-vehicle at time T1 and left the lane at time T2. In such a case, inter-vehicle distance information changes abruptly, and a relative speed computation value (a differentiated value of inter-vehicle distance information) becomes extremely large at time T1 and extremely small at time T2. Furthermore, after-filtering signal values are influenced by these extreme values, so that a time lag of some magnitude (e.g., ΔT1 and ΔT2) occurs between an after-filtering signal value and a value close to a before-filtering signal value, as shown in FIG. 9.

As described above, in the case where an inter-vehicle distance signal output by an inter-vehicle distance sensor changes abruptly by interruption, etc., a relative speed computation value based upon this inter-vehicle distance signal is computed as a wrong value not agreeing with the actual situation. Furthermore, if a filtering process is performed to remove noise, there is a problem that relative speeds not agreeing with the actual situation will be computed over many cycles. Moreover, if the ECU recognizes wrong relative speeds over many cycles, there is a problem that inter-vehicle distance control will be performed based upon wrong information (relative speeds not agreeing with the actual situation)

Note that if an output value from the inter-vehicle distance sensor, as it is, is used as an inter-vehicle distance signal for computing a relative speed, the influence of noise is great and therefore the inter-vehicle distance signal is obtained by smoothing the output value of the inter-vehicle distance sensor by a filtering process. However, even in this filtering process, when an output value from the inter-vehicle distance sensor changes abruptly by interruption, etc., there is a problem that wrong values not agreeing with the actual situation will be output as inter-vehicle distance signals.

### SUMMARY OF THE INVENTION

The present invention has been made in view of the problems described above. Accordingly, it is an object of the present invention to provide a relative speed computing apparatus and inter-vehicle distance control apparatus that are capable of being suitably employed in an automatic cruise control apparatus and are capable of removing noise contained in a differentiated value (relative speed computation value) of inter-vehicle distance information. Another object of the present invention is to provide a relative speed computing apparatus and inter-vehicle distance control apparatus which are capable of quickly computing an accurate relative speed agreeing with the actual situation, even in the case a wrong relative speed not agreeing with the actual situation is computed because of the interruption of a preceding vehicle or the lane change of a self-vehicle by differentiating inter-vehicle distance information.

To achieve the above objects, a relative speed computing apparatus of the present invention comprises four major components: (1) inter-vehicle distance detecting means for detecting inter-vehicle distance information between a self-vehicle and other vehicle traveling in front or rear of the self-vehicle; (2) relative speed computing means for computing relative speed information between the self-vehicle and the other vehicle on the basis of the inter-vehicle distance information; (3) filter means for performing a filtering process on the relative speed information computed by the relative speed computing means; and (4) switch means switchable so that when a rate of change in a relative speed computation value computed by the relative speed computing means is a predetermined value or greater or when a rate of change in the after-filtering relative speed information filtered by the filter means is the predetermined value or greater, approximately zero is output as a relative speed, and so that when the rate of change in the relative speed computation value is less than the predetermined value or when the rate of change in the after-filtering relative speed information is less than the predetermined value, the after-filtering relative speed information is output as a relative speed. The relative speed is judged based on an output value of the switch means.

According to the relative speed computing apparatus of the present invention, when there is no abrupt change in inter-vehicle distance information that results from a lane change, etc., after-filtering relative speed information suppressing the influence of noise can be computed by performing the filtering process on a relative speed computation value. On the other hand, when inter-vehicle distance information changes abruptly and therefore a rate of change in the computed relative speed information is a predetermined value or greater, the after-filtering relative speed information is made zero. As a result, computations of relative speed not agreeing with the actual situation are prevented.

In the relative speed computing apparatus of the present invention, the aforementioned filter means preferably computes the relative speed computation value in a preset computation cycle and performs a filtering process which meets the following relation:
F(n)=aF(n−1)+bL(n)
where F(n) is first after-filtering relative speed information in a first computation cycle n, L(n) is a first relative speed computation value in the first computation cycle n, F(n−1) is second after-filtering relative speed information in a second computation cycle (n−1) one before the first computation cycle n, a+b=1, a>0, and b>0.

In this case, stable relative speed information can be computed while reliably removing noise contained in the relative speed computation value.

In a third computation cycle where the rate of change in the relative speed computation value computed by the relative speed computing means or the rate of change in the after-filtering relative speed information filtered by the filter means is the predetermined value or greater, the switch means preferably sets the after-filtering relative speed information to zero. In each of the subsequent computation cycles after the third computation cycle, the filter means preferably performs the filtering process based on the after-filtering relative speed information set to zero by the switch means.

In this case, when there is an abrupt change in relative speed, the relative speed is recognized as zero. And in the subsequent computation cycles, the filtering process is performed based on the relative speed recognized as zero. Therefore, in the current computation cycle and subsequent computation cycles, there is no influence of a wrong relative speed computation value obtained at the time of an abrupt change in a relative speed computation value. After-filtering relative speed information, computed in each computation cycle after an abrupt change in relative speed, converges to a value close to a relative speed computation value, so that the response can be improved. In addition, noise contained in relative speed computation values is reliably removed, so that stable after-filtering relative speed information can be obtained.

In the relative speed computing apparatus of the present invention, the aforementioned rate of change in the relative speed computation value is preferably detected based on a difference between the first relative speed computation value L(n) obtained in the first computation cycle n by the relative speed computing means and a second relative speed computation value L(n−1) obtained in the second computation cycle n−1 by the relative speed computing means.

In this case, the rate of change in the relative speed computation value can be quickly and reliably sensed by the difference between the current value and a relative speed computation value one computation cycle before the current value.

The relative speed computing apparatus of the present invention may further comprise inter-vehicle distance filter means for performing a filtering process on the inter-vehicle distance information detected by the inter-vehicle distance detecting means. The relative speed computing means preferably computes the relative speed information based on the after-filtering inter-vehicle distance information filtered by the inter-vehicle distance filter means.

In this case, because the inter-vehicle distance information detected by the inter-vehicle distance detecting means is filtered by the inter-vehicle distance filter means, noise contained in the inter-vehicle distance information is reliably removed and stable after-filtering inter-vehicle distance information can be obtained. Furthermore, since the relative speed computing means computes a relative speed computation value based on the after-filtering inter-vehicle distance, a relative speed can be judged based on a stable relative speed computation value in which the amplitude of noise is small.

Preferably, the aforementioned inter-vehicle distance detecting means (1) performs a filtering process on an output value of an inter-vehicle distance sensor; (2) when a rate of change in the after-filtering output value filtered by the inter-vehicle distance detecting means is a predetermined value or greater, outputs the output value of the inter-vehicle distance sensor as the inter-vehicle distance information; and (3) when the rate of change in the after-filtering output value is less than the predetermined value, outputs the after-filtering output value as the inter-vehicle distance information.

In this case, the filtering process is performed on the output value of an inter-vehicle distance sensor. When a rate of change in the after-filtering output value is a predetermined value or greater, the output value of the inter-vehicle distance sensor is output as the inter-vehicle distance information. Also, when the rate of change in the after-filtering output value is less than the predetermined value, the after-filtering output value is output as the inter-vehicle distance information. Therefore, noise is suitably removed, and even in the case where the output value of the inter-vehicle distance sensor changes abruptly by the appearance of an interrupt inter-vehicle distance information can be output with good response, and a relative speed computed based on the inter-vehicle distance information can be output.

An inter-vehicle distance control apparatus of the present invention comprises two major components: (1) acceleration-deceleration means for accelerating or decelerating a self-vehicle; and (2) acceleration-deceleration control means for actuating the acceleration-deceleration means based on an output value of the switch means of the aforementioned relative speed computing apparatus.

According to the inter-vehicle distance control apparatus of the present invention, the self-vehicle is accelerated or decelerated based on a relative speed agreeing with the actual situation. Therefore, even when a value detected by the inter-vehicle distance sensor changes abruptly by a lane change, etc., the acceleration or deceleration of the self-vehicle is performed by judging a relative speed accurately. Thus, satisfactory inter-vehicle distance control can be performed.

The inter-vehicle distance control apparatus of the present invention may further comprise: (1) vehicle speed detecting means for detecting a vehicle speed of the self-vehicle; (2) target inter-vehicle distance setting means for setting a target inter-vehicle distance between the self-vehicle and a preceding vehicle; and (3) target vehicle speed setting means for setting a target speed of the self-vehicle, based on the vehicle speed detected by the vehicle speed detecting means, the target inter-vehicle distance set by the target inter-vehicle distance setting means, and the output value of the switch means. The aforementioned acceleration-deceleration control means accelerates or decelerates the self-vehicle according to the target speed.

According to the inter-vehicle distance control apparatus of the present invention, a target speed of the self-vehicle is set based on the vehicle speed of the self-vehicle, target inter-vehicle distance, and relative speed, so that the self-vehicle can be quickly accelerated or decelerated according to the target speed.

### BRIEF DESCRIPTION OF THE DRAWINGS

The present invention will be described in further detail with reference to the accompanying drawings wherein:

FIG. 1 is a block diagram showing an automatic cruise control apparatus to which a relative speed computing apparatus and inter-vehicle distance apparatus according to a first embodiment of the present invention are applied;

FIG. 2 is a circuit diagram schematically showing a computing circuit associated with a filtering process that is performed by filter means provided in the relative speed computing apparatus and inter-vehicle distance apparatus constructed in accordance with the first embodiment of the present invention;

FIG. 3 is a circuit diagram schematically showing after-filtering relative speed acquiring means provided in the relative speed computing apparatus and inter-vehicle distance apparatus constructed in accordance with the first embodiment of the present invention;

FIG. 4 is a flowchart showing processing steps that are carried out by the filter control means of the first embodiment of the present invention;

FIG. 5 is a graph used for explaining the relative speed computing apparatus and inter-vehicle distance apparatus constructed in accordance with the first embodiment of the present invention and also showing changes in inter-vehicle distance information (relative speed computation value) and after-filtering signal values;

FIG. 6 is a circuit diagram schematically showing a computing circuit, in which a filtering process is performed on inter-vehicle distance information, provided in a relative speed computing apparatus constructed in accordance with a second embodiment of the present invention;

FIG. 7 is a flowchart showing processing steps that are carried out by the relative speed computing apparatus of the second embodiment of the present invention;

FIG. 8 is a graph showing changes in inter-vehicle distance information according to the relative speed computing apparatus of the second embodiment of the present invention;

FIG. 9 is a graph showing changes in before-filtering signal values and after-filtering signal values as to relative speed computation values employed in a conventional inter-vehicle distance control apparatus; and

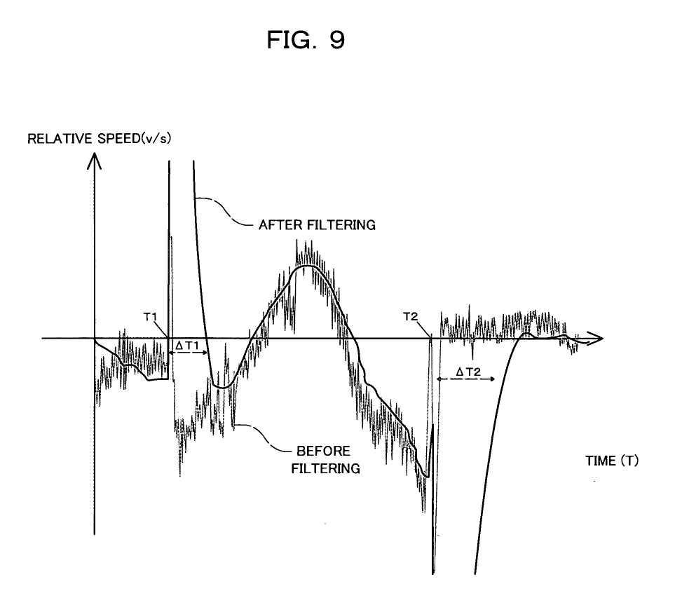

FIG. 10 is a graph showing changes in signal values obtained by filtering the output value of an inter-vehicle distance sensor provided in conventional inter-vehicle distance detecting means.

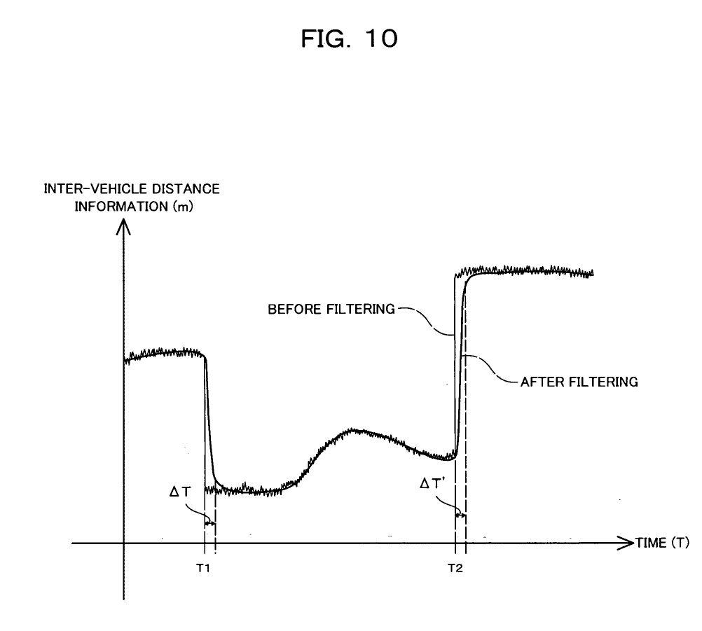

### DESCRIPTION OF THE PREFERRED EMBODIMENTS

Embodiments of the present invention will be described hereinafter with reference to the drawings.

(First Embodiment)

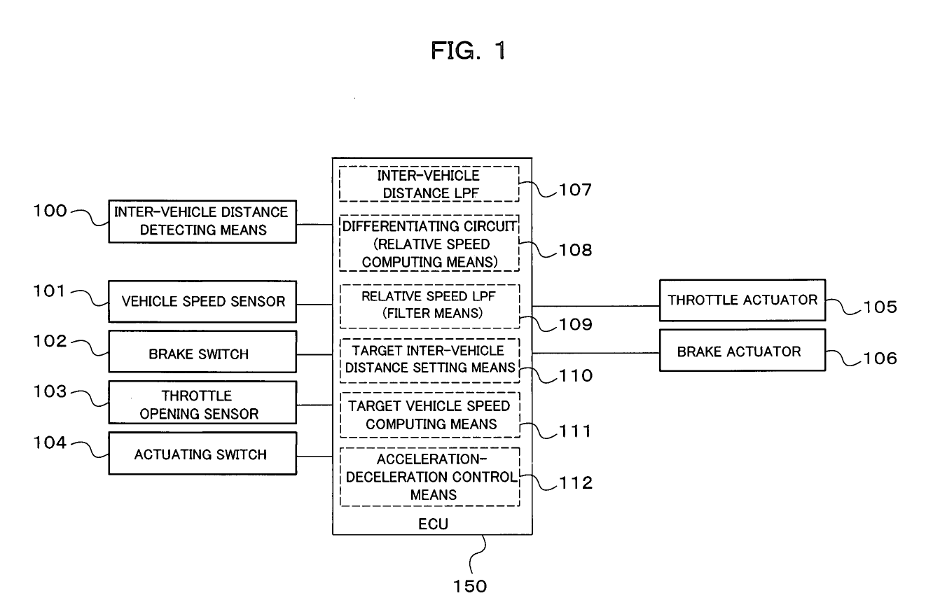

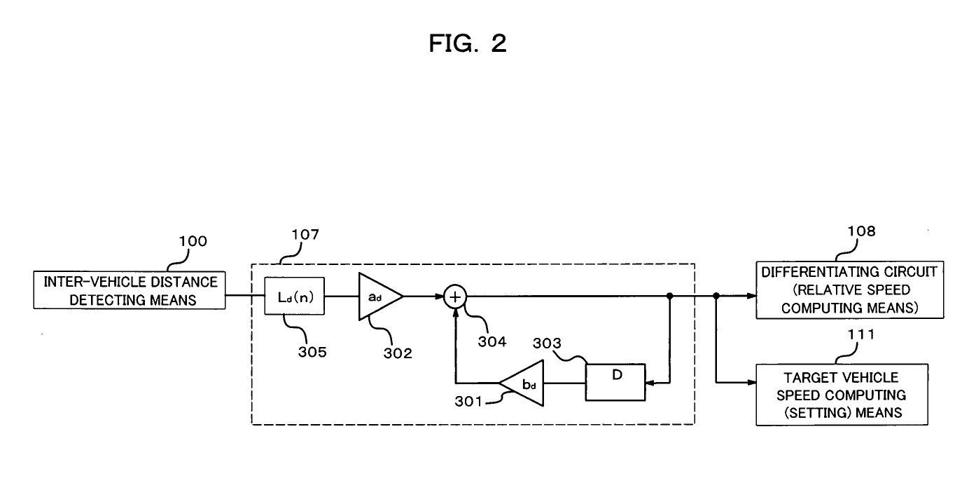

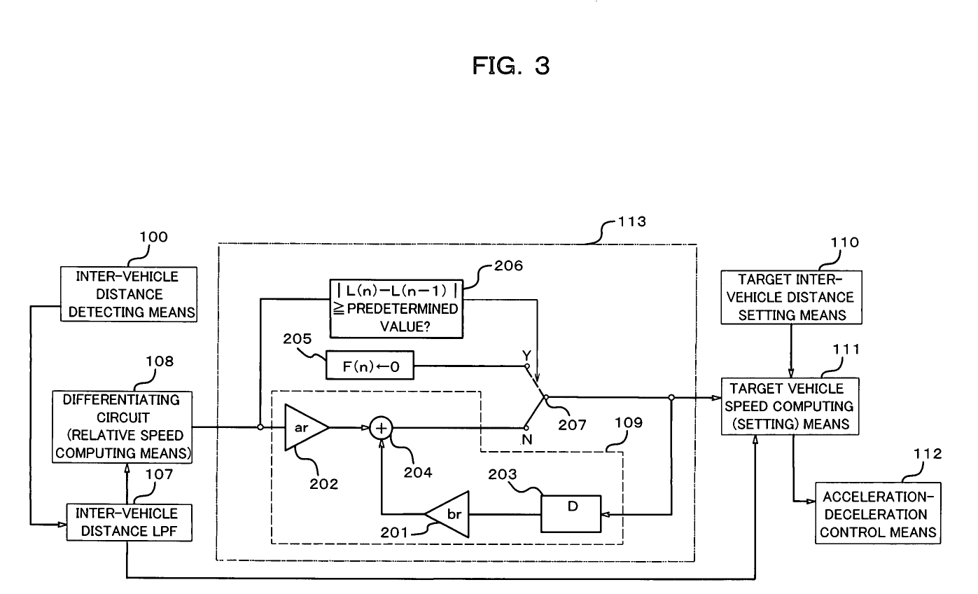

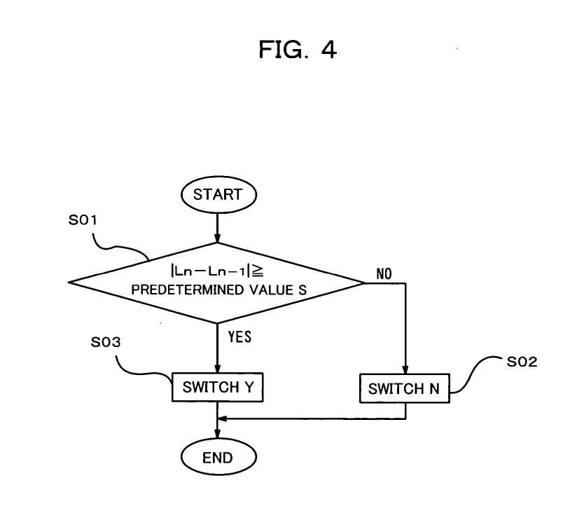

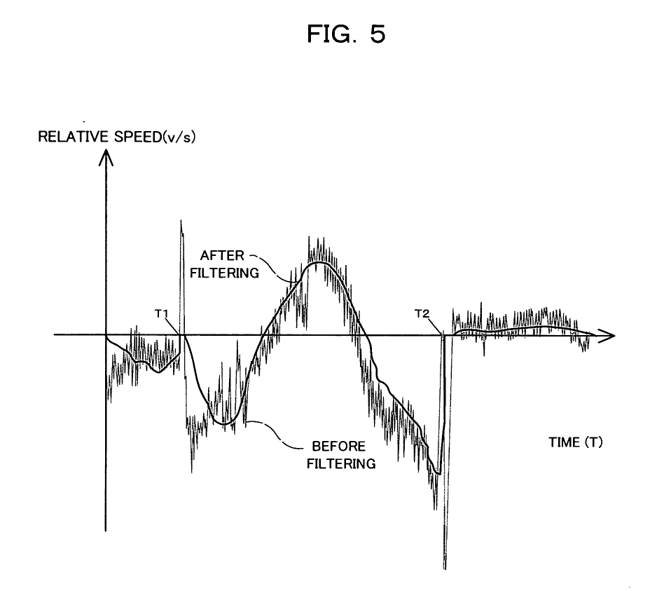

FIGS. 1 to 5 are used for explaining a relative speed computing apparatus and inter-vehicle distance control apparatus constructed in accordance with a first embodiment. FIG. 1 is a block diagram showing the construction; FIG. 2 is a circuit diagram schematically showing a computing circuit associated with a filtering process that is performed by inter-vehicle filter means; FIG. 3 is a circuit diagram schematically showing the functional construction in an electronic control unit (ECU) and a computing circuit associated with a filtering process for a relative speed computation value; FIG. 4 is a flowchart used for explaining the filtering process; and FIG. 5 is a graph showing changes in relative-speed information (relative speed computation value) and after-filtering signal values in this embodiment.

This embodiment applies the relative speed computing apparatus and inter-vehicle distance control apparatus of the present invention to an automatic cruise control apparatus. In this automatic cruise control apparatus, when there is no preceding vehicle ahead of the self-vehicle, or when the inter-vehicle distance D between the self-vehicle and a preceding vehicle is sufficiently longer than an inter-vehicle distance threshold value Ds, the self-vehicle is automatically traveled at a set speed V0 (fixed-speed control mode). When the inter-vehicle distance D is shorter than the inter-vehicle distance threshold value Ds, the inter-vehicle distance D is controlled by accelerating or decelerating the self-vehicle so that the inter-vehicle distance D maintains a target inter-vehicle distance Dt (inter-vehicle control mode).

The inter-vehicle distance threshold value Ds may be set to the detection limit value of an inter-vehicle distance sensor, or it maybe set smaller than the detection limit value.

As shown in FIG. 1, the automatic cruise control apparatus in this embodiment is equipped with an ECU 150 (which comprises memory devices (ROM, RAM) and a central processing unit (CPU), etc.), inter-vehicle distance detecting means (inter-vehicle distance sensor) 100, a vehicle speed sensor 101, a brake switch 102, a throttle opening sensor 103, and an actuating switch 104. It is further equipped with a throttle actuator 105 and a brake actuator 106.

The inter-vehicle distance detecting means (inter-vehicle distance sensor) 100, vehicle speed sensor 101, brake switch 102, throttle opening sensor 103, and actuating switch 104 are connected to the input side of the ECU 150, while the throttle actuator 105 and brake actuator 106 are connected to the output side of the ECU 150.

The vehicle speed sensor 101, brake switch 102, and throttle opening sensor 103 are sensors to detect information such as the travel speed of the self-vehicle, on/off state of a brake pedal (not shown), and opening of a throttle valve (not shown), respectively. The actuating switch 104 is one to instruct the ECU 150 to start automatic cruise control. When the actuating switch 104 is made on by the vehicle's driver, the vehicle speed at that time is set to the set vehicle speed V0, thereby starting automatic cruise control. Note that the actuating switch 104 has the function of increasing or reducing the set speed V0 at the time of automatic cruise control.

The releasing of automatic cruise control can be performed by making the actuating switch 104 off. The automatic cruise control can also be released even by actuation of the brake sensed with a signal from the brake switch 102.

The inter-vehicle distance detecting means (inter-vehicle distance sensor) 100 is a sensor to detect the presence of an object (such as a preceding vehicle) ahead of the self-vehicle and the inter-vehicle distance between the self-vehicle and a preceding vehicle by a laser radar, etc. In this embodiment, the detected inter-vehicle distance information is output as a voltage value signal. Note that in this embodiment, the detection limit value of the inter-vehicle distance sensor 100 is 150 meters. When there is no preceding vehicle, or when inter-vehicle distance is greater than the detection limit value, the inter-vehicle distance detecting means 100 outputs the detection limit value (150 meters) as inter-vehicle distance information.

The ECU 150 is equipped with an inter-vehicle distance LPF (low-pass filter) 107, a differentiating circuit (relative speed computing means) 108, a relative speed LPF (low-pass filter as filter means) 109, target inter-vehicle distance setting means 110, target vehicle speed computing means (target vehicle speed setting means) 111, and acceleration-deceleration control means 112.

An inter-vehicle distance detection signal, input from the inter-vehicle distance detecting means 100 to the ECU 150, is filtered by the inter-vehicle distance LPF 107. With this filtering process, very low noise contained in the inter-vehicle distance detection signal (inter-vehicle distance information) is removed and a stable signal value (after-filtering inter-vehicle distance information) containing less unwanted noise is obtained. The after-filtering inter-vehicle distance information is input to the target vehicle speed computing means 111.

The after-filtering inter-vehicle distance information obtained by the inter-vehicle distance LPF 107 is also input to the differentiating circuit (relative speed computing means) 108. The differentiating circuit 108 performs a differentiating process on the input after-filtering inter-vehicle distance information, thereby computing relative speed information (relative speed computation value).

The computed relative speed computation value is input to the relative speed LPF 109 and undergoes a filtering process there. With this filtering process, very low noise contained in the relative speed computation value output from the differentiating circuit 108 is removed and a stable signal value (after-filtering relative speed information) containing less unwanted noise is obtained. Allowing for an amount of change in the output value from the differentiating circuit 108, a final relative speed is computed.

The above-mentioned filtering process and computation of relative speed will be described in detail later.

Target inter-vehicle distance information has been stored in the target inter-vehicle distance setting means 110 as a map corresponding to the vehicle speed V of the self-vehicle input from the vehicle speed sensor 101. The target inter-vehicle distance setting means 110 sets target inter-vehicle distance information (target inter-vehicle distance) D0 based on the vehicle speed V of the self-vehicle.

When the inter-vehicle distance (after-filtering inter-vehicle distance information) D input from the inter-vehicle distance LPF 107 is the inter-vehicle distance threshold value Ds or greater, the target vehicle speed computing means 111 judges that there is no preceding vehicle ahead of the self-vehicle or there is a sufficient inter-vehicle distance between the self-vehicle and a preceding vehicle, and sets the automatic cruise set speed V0 to a target vehicle speed Vt and sends out it to the acceleration-deceleration control means 112 (fixed-speed mode).

When the inter-vehicle distance D is less than the inter-vehicle distance threshold value Ds, the target vehicle speed computing means 111 computes a target vehicle speed Vt, using the following Eqs. (A) and (B):
ΔVn=Dn−Dn−1 (A)
Vtn =Vn+a(Dn−Dtn)+bΔVn (B)
where Dn is the current inter-vehicle distance in the computation cycle n, Dn−1 is an inter-vehicle distance in a computation cycle n−1 one before the current cycle n, ΔVn is the relative speed (after-filtering relative speed information) input from the relative speed LPF 109, Dtn is the target inter-vehicle distance input from the target inter-vehicle distance setting means 110, and Vn is the vehicle speed of the self-vehicle input from the vehicle speed sensor 102. However, when the calculated target vehicle speed Vt is greater than the automatic cruise set speed V0, the set speed V0 is set to the target vehicle speed Vt. The target vehicle speed Vt thus set is input to the acceleration-deceleration control means 112.

Note that the relative speed ΔV, as shown in Eq.(A), becomes positive in the direction where the inter-vehicle distance between the self-vehicle and a preceding vehicle becomes longer. Also, a and b in Eq.(B) are suitably set filter coefficients.

In the acceleration-deceleration control means 112, the feedback control of accelerating or decelerating the self-vehicle is performed so that the input speed of the self-vehicle becomes the target vehicle speed Vt. Therefore, in the fixed-speed mode, the self-vehicle travels at the set vehicle speed V0, while in the inter-vehicle distance mode the inter-vehicle distance between the self-vehicle and a preceding vehicle is maintained at the target inter-vehicle distance D0.

Next, the process of computing after-filtering relative speed information (also called an after-filtering signal value) by the inter-vehicle distance LPF 107 and after-filtering relative speed acquiring means 113 which contains the relative speed LPF 109, and the computation of relative speed by the relative speed computing means 108, will be described with reference to FIGS. 2 and 5.

As shown in FIG. 2, the inter-vehicle distance LPF 107 comprises a first amplifier 301, a second amplifier 302, a delay element 303, an adder circuit 304, and a signal recognizing section 305.

The inter-vehicle distance information signal (voltage value) detected by the inter-vehicle distance sensor 100 is first input to the signal recognizing section 305 of the inter-vehicle distance LPF 107. The signal recognizing section 305 recognizes the value of an inter-vehicle distance detection signal input at computation cycles (e.g., at computation cycles of 20 milliseconds) and outputs the recognized value as an inter-vehicle distance detection signal value Ld(n).

The first amplifier 301 is interposed between the delay element 303 and the adder circuit 304, while the second amplifier 302 is interposed between the signal recognizing section 305 and the adder circuit 304. The first amplifier 301 and second amplifier 302 multiply input signal values by respectively set filter coefficients ad and bd (where ad+bd=1, ad>0, and bd>0) and output the computed values.

The filter coefficients ad and bd are set beforehand so that a very small change (noise) in the detection signal value Ld(n) can be sufficiently removed. In this case, the larger the filter coefficient ad (the smaller the filter coefficient bd), the higher the noise that can be removed. However, because the response delay to a change in the inter-vehicle distance detection signal value Ld(n) becomes longer, the filter coefficients ad and bd are set to values such that noise can be reliably removed and, at the same time, the response delay to a change in the inter-vehicle distance detection signal value Ld(n) does not become too long.

Signal values from the first and second amplifiers 301, 302 are input to the adder circuit 304, which adds and outputs the input signal values. The delay element 303 is interposed between the adder circuit 304 and the first amplifier 301 so that a signal value (i.e., after-filtering inter-vehicle distance information) input from the adder circuit 304 is delayed and output by one computation cycle (20 milliseconds).

Thus, the inter-vehicle distance detection signal value Ld(n), input from the signal recognizing section 305 to the second amplifier 302, is multiplied by the filter coefficient ad. The second amplifier 302 inputs the computed signal value adLD(n) to the adder circuit 304. An after-filtering signal value Fd(n−1) in a computation cycle one before the current computation cycle n is input from the delay element 303 to the first amplifier 301. The first amplifier 301 multiplies the input after-filtering signal value Fd(n−1) by the filter coefficient bd and inputs the computed signal value bdFd(n−1) to the adder circuit 304.

The adder circuit 304 adds the signal value bdFd(n−1) input from the first amplifier 301 and the signal value adLd(n) input from the second amplifier 302 and outputs the added signal value bdFd(n−1)+adLd(n).

That is, in the overall operation of the inter-vehicle distance LPF 107, the input inter-vehicle distance detection signal value Ld(n) is converted into a signal value Fd(n) by the following Eq. (C) and is output therefrom.
Fd(n)=bdFd(n−1)+adLd(n) (C)

The after-filtering inter-vehicle distance information Fd(n), filtered at computation cycles of 20 milliseconds in the inter-vehicle distance LPF 107, is input to the differentiating circuit (relative speed computing means) 108 and target vehicle speed setting means 111.

The differentiating circuit 108 is well known in the prior art and comprises a capacitor, an amplifying circuit, etc., which are not shown. The differentiating circuit 108 computes a rate of change in the after-filtering inter-vehicle distance information Fd(n) (i.e., a differentiated value) input at computation cycles of 20 milliseconds. The differentiated value Lr(n) of the after-filtering inter-vehicle distance information is obtained by computing a difference between the current after-filtering inter-vehicle distance signal value Fd (n) input in the computation cycle n and an after-filtering inter-vehicle distance signal value Fd(n−1) input in a computation cycle n−1 one before the current computation cycle n.

The rate of change Lr(n) in the after-filtering inter-vehicle distance information that is computed in the differentiating circuit 108 is a difference in speed (relative speed) between the self-vehicle and a preceding vehicle. That is, the differentiating circuit 108 computes relative speed information from inter-vehicle distance information at computation cycles of 20 milliseconds and inputs it to the after-filtering relative speed acquiring means 113 that contains a relative speed LPF 109.

As shown in FIG. 3, the after-filtering relative speed acquiring means 113, in addition to the relative speed LPF 109, comprises zero value setting means 205, relative speed change judging section 206, and a switch (switch means) 207.

The relative speed LPF 109 comprises a first amplifier 201, a second amplifier 202, a delay element 203, and an adder circuit 204.

The first amplifier 201 and second amplifier 202 multiply input signal values by respectively set filter coefficients ar and br (where ar+br=1, ar>0, and br>0) and output the computed values.

The filter coefficients ar and br are set beforehand so that a very small change (noise) in the relative speed computation value Lr(n) can be sufficiently removed. As in the above case, the larger the filter coefficient ar (the smaller the filter coefficient br) the higher the noise that can be removed. However, because the response delay to a change in the relative speed computation value Lr(n) becomes longer, the filter coefficients ar and br are set to values such that noise can be reliably removed and, at the same time, the response delay to a change in the relative speed computation value Lr(n) does not become long.

The delay element 203 is interposed between the switch 207 and the first amplifier 201 so that a signal value input via the switch 207 is delayed and output by one computation cycle (20 milliseconds). Signal values from the first and second amplifiers 201, 202 are input to the adder circuit 204, which adds and outputs the input signal values.

Thus, the relative speed computation value Lr(n) input in the current computation cycle n from the differentiating circuit 108, is input to the second amplifier 202 of the relative speed LPF 109 and to the relative speed change judging section 206.

The second amplifier 202 multiplies the input relative speed computation value Lr(n) by the filter coefficient ar and sends out the computed signal value arLr(n) to the adder circuit 204.

On the other hand, an after-filtering signal value Fr(n−1) in a computation cycle n−1 one before the current computation cycle n is input from the delay element 203 to the first amplifier 201. The first amplifier 201 multiplies the input after-filtering signal value Fr(n−1) by the filter coefficient br and sends out the computed signal value brFr(n−1) to the adder circuit 204.

The adder circuit 204 adds the signal value brFr(n−1) input from the first amplifier 201 and the signal value arLr(n) input from the second amplifier 202 and outputs the added signal value brFr(n−1)+arLr(n).

That is, in the overall operation of the relative speed LPF 109, the input relative speed computation value Lr(n) is converted into the after-filtering signal value Fr(n) by the following Eq. (D) and is output therefrom.
Fr(n)=brFr(n−1)+arLr(n) (D)

One end (output end) of the switch 207 is fixed, and by conducting current through a solenoid (not shown) the other end (input end) is connected with or disconnected from the terminals on the Y and N sides.

The fixed output terminal is connected to the target vehicle speed computing means 111 and to the delay element 203 of the relative speed LPF 109. The input terminal on the Y side is connected to the zero value setting means 205. The input terminal on the N side is connected to the output side of the relative speed LPF 109.

Note that the zero value setting means 205 outputs a signal value representing a relative speed 0 at all times.

The relative speed change judging section 206 receives the relative speed computation value Lr(n) from the differentiating circuit 108. The input relative speed computation value Lr(n) is stored on the internal storage device of the relative speed change judging section 206.

Furthermore, the relative speed change judging section 206 computes a difference between the current relative speed computation value Lr(n) in the current computation cycle n and the stored relative speed computation value Lr(n−1) in a computation cycle n−1 one before the current computation cycle n, and compares the computed value with a predetermined value S.

And the switch 207 is controlled as follows. That is, when the difference between the current relative speed computation value Lr(n) and the previous relative speed computation value Lr(n−1) is less than the predetermined value S (i.e., when a rate of change in the relative speed computation value is small), the switch 207 is connected to the terminal on the N side. On the other hand, when the above-mentioned difference is the predetermined value S or greater (i.e., when a rate of change in the relative speed computation value is large), the switch 207 is connected to the terminal on the Y side. Note that the predetermined value S is set beforehand.

Therefore, in the case where the switch 207 is being connected to the terminal on the N side (i.e., in the case of |Lr(n)−Lr(n−1)|≦ predetermined value S), the after-filtering signal value Fr(n) is output from the relative speed LPF 109 and is input to the target vehicle speed computing means 111 and to the delay element 203 of the relative speed LPF 109.

In the case where the switch 207 is being connected to the terminal on the Y side (i.e., in the case of ILr(n)−Lr(n−1)|> predetermined value S), a signal representing a relative speed 0 is input from the zero value setting means 205. At this time, the target vehicle speed computing means 111, and the delay element 203 of the relative speed LPF 109, recognize the relative speed to be zero.

The relative speed computing apparatus and inter-vehicle distance control apparatus according to the first embodiment of the present invention (particularly, the after-filtering relative speed acquiring means 113) is constructed as described above. Therefore, as shown in FIG. 4, in step S01, the relative speed change judging section 206 computes a difference between the current relative speed computation value Lr(n) and the relative speed computation value Lr(n−1) in a computation cycle n−1 one before the current computation cycle n. In the case where the computed difference is less than the predetermined value S, the relative speed change judging section 206 judges that a rate of change in the inter-vehicle distance information (detection signal) detected by the inter-vehicle distance sensor 100 is less than the predetermined value, and advances to step S02.

In step S01, in the case where the difference between the current relative speed computation value Lr(n) and the previous relative speed computation value Lr(n−1) is the predetermined value S or greater, the relative speed change judging section 206 judges that a rate of change in the inter-vehicle distance information (detection signal) detected by the inter-vehicle distance sensor 100 is the predetermined value S or greater, and advances to step S03.

In step S02, the relative speed change judging section 206 connects the switch 207 to the terminal on the N side. Therefore, the after-filtering signal value Fr(n), obtained by making a filtering computation (Fr(n)=brFr(n−1)+arLr(n)) on the basis of the current relative speed computation value Lr(n) and the previous relative speed computation value Lr(n−1), is output from the relative speed LPF 109 through the switch 207. At this time, ar+br=1, ar>0, and br>0.

In step S03, the relative speed change judging section 206 connects the switch 207 to the terminal on the Y side. Therefore, a signal value representing a relative speed 0 is output from the zero value setting means 205. The target vehicle speed computing means 111, and the delay element 203 of the relative speed LPF 109, recognize that the relative speed information is 0.

Therefore, when there is no abrupt change in a relative speed computation value, the relative speed LPF 109 performs the above-mentioned filtering computation on the relative speed computation value that is output from the differentiating circuit 108. That is, by adding the current relative speed computation value Lr(n) and the previous relative speed computation value Lr(n−1) in a predetermined ratio to smooth a detection signal that changes finely, stable after-filtering relative speed information Fr(n) is obtained. Thus, the target vehicle speed computing means 111 is able to set a stable target vehicle speed Vt.

In this embodiment, as shown in FIG. 5, in the computation cycle where, when inter-vehicle distance becomes short abruptly by the appearance of an interrupt vehicle at time T1 or when inter-vehicle distance becomes long abruptly by the disappearance of an interrupt vehicle at time T2, an abrupt change in inter-vehicle distance occurs and therefore the relative speed computation value Lr(n) changes extremely, the relative speed recognizing means recognizes the after-filtering relative speed information Fr(n) as zero. Therefore, in the case where the filter computation is performed in each of the subsequent computation cycles, there is no influence of the relative speed computation value Lr(n) that is an extreme value before an abrupt change in inter-vehicle distance, and consequently, the after-filtering signal value Fr(n) becomes a value close to a relative speed computation value Lr(n) agreeing with the actual situation immediately after an abrupt change in an inter-vehicle distance computation value. Accordingly, while unwanted noise contained in the relative speed computation value Lr(n) is being removed, relative speed information (after-filtering signal value) agreeing with the actual situation can be input to the target vehicle speed computing means 111, which is able to set a stable target vehicle speed Vt without substantially undergoing the influence of wrong relative speed information.

While the first embodiment of the present invention has been described, the invention is not to be limited to the above-mentioned embodiment, but may be modified within the scope of the invention.

In the first embodiment, although the target vehicle speed setting means 111 computes a target vehicle speed by using after-filtering relative speed information, the use of after-filtering relative speed information is not to be limited to this example.

For example, even in the feedback control of accelerating or decelerating a self-vehicle by throttle control on the basis of a target inter-vehicle distance and a detected inter-vehicle distance without setting a target vehicle speed based on relative speed information in normal conditions, there is a possibility that throttle control alone cannot decelerate the self-vehicle sufficiently, when a relative speed is negative and the absolute value is a predetermined value or greater (i.e., when the self-vehicle is rapidly approaching a preceding vehicle). Therefore, for example, in the case where a relative speed is negative and the absolute value is a predetermined value or greater, a warning may be given to the vehicle's driver, or the self-vehicle may be decelerated by applying the brake.

Depending upon inter-vehicle distance sensors, it is conceivable that when an inter-vehicle distance is long, the amplitude of noise contained in an inter-vehicle distance detection signal will increase because of a reduction in sensor detection accuracy, etc. It is also conceivable that the amplitude of noise in a relative speed computation value obtained by differentiating inter-vehicle distance information will increase. Because of this, there is a possibility that a variation in the relative speed computation value Lr(n) due to noise will be judged to be a variation in the relative speed computation value Lr(n) due to an actual change in relative speed.

In such a case, it is preferable that the predetermined value S in the above-mentioned embodiment be set to different values between the case of a small inter-vehicle distance detection signal value Ld(n) and the case of a large inter-vehicle distance detection signal value Ld(n). Of course, when the inter-vehicle distance detection signal value Ld(n) is large the predetermined value S is set large, and when the inter-vehicle distance detection signal value Ld(n) is small the predetermined value S is set small. Furthermore, the predetermined value S may be set to two or more different values, depending upon the magnitude of the inter-vehicle distance detection signal value Ld(n).

In this manner, even when an inter-vehicle distance is long and the amplitude of noise in a signal detected by an inter-vehicle distance sensor increases, there is no possibility that a variation in a detection signal value due to noise will be judged as an abrupt change in inter-vehicle distance. In addition, in the case of a long inter-vehicle distance, an amount of change in inter-vehicle distance due to an interrupt vehicle, etc. is generally large, so when inter-vehicle distance changes abruptly, an abrupt change in inter-vehicle distance can be accurately judged.

Even in the case where the speed of a self-vehicle increases, it is conceivable that the amplitude of noise in an inter-vehicle distance detection signal will increase because of sensor vibration, etc. Accordingly, the filter coefficients ar, br, ad, and bd in the above-mentioned embodiment are not limited to fixed values. For instance, when the detection signal value Ld(n) (inter-vehicle distance) is large the filter coefficients ar and ad may be set large (filter coefficients br and bd may be set small), and when the detection signal value Ld(n) (inter-vehicle distance) is small the filter coefficients ar and ad may be set small (filter coefficients br and bd may be set large). In this manner, even when an inter-vehicle distance is long and the amplitude of noise in the inter-vehicle distance detection signal is large, noise can be reliably removed. In addition, in the case of a short inter-vehicle distance, a filtering process with good response can be carried out.

In the above-mentioned embodiment, a rate of change in the relative speed is judged by the comparison of the current relative speed computation value Lr(n) with the relative speed computation value Lr(n−1) in a computation cycle n−1 one before the current computation cycle n, or the comparison of the current after-filtering signal value Fr(n) with the after-filtering signal value Fr(n−1) in a computation cycle n−1 one before the current computation cycle n. However, to judge an abrupt change in the relative speed more reliably, a rate of change in the relative speed may be judged by the comparison of the current signal value Lr(n) with the signal value Lr(n−t) in a computation cycle n−t that is t (where t is an integer≧2) before the current computation cycle n, or the comparison of the current signal value Fr(n) with the signal value Fr(n−t) in a computation cycle n−t that is t before the current computation cycle n. In this case, as the value of t becomes larger, more reliable judgments can be made, but since the response to a change in inter-vehicle distance becomes worse, it is desirable to set the value of t in a range where response is not reduced (e.g., t=2).

When the inter-vehicle distance information detected by the inter-vehicle distance detecting means 100, or the inter-vehicle distance information filtered by the inter-vehicle distance LPF 107, changes abruptly, the relative speed computation value also changes abruptly. Therefore, when the difference between the current inter-vehicle distance information and an inter-vehicle distance information in a computation cycle one before the current computation cycle is a predetermined value or greater, a rate of change in the relative speed computation value can be judged to be greater than a predetermined rate of change.

The computation cycle in the above-mentioned embodiment is not limited to 20 milliseconds, but it may be suitably changed. Instead of or in addition to the condition that a rate of change in the relative speed is a predetermined value or greater, there may be used the condition that the absolute value of the relative speed is a predetermined value or greater. The reason is because even this case can sense an abrupt change in the output value of the inter-vehicle distance sensor due to a lane change, etc.

(Second Embodiment)

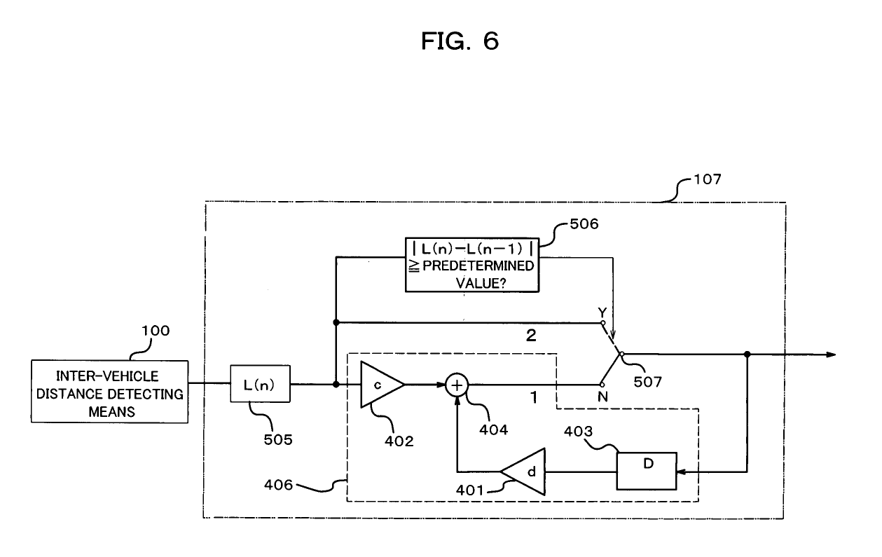

Next, a second embodiment of the present invention will be described. The second embodiment is the same in major components as the first embodiment, but has a different inter-vehicle distance LPF. Therefore, only the inter-vehicle distance LPF will be described with reference to FIGS. 6 to 8.

As shown in FIG. 6, the inter-vehicle distance LPF 107 comprises a signal recognizing section 505, a low-pass filter (LPF) 406, and an inter-vehicle distance change judging section 506 and switch 507 (switch means) The LPF 406 comprises a first amplifier 401, a second amplifier 402, a delay element 403, and an adder circuit 404. The first amplifier 401, second amplifier 402, delay element 403, and adder circuit 404 do not need to be individual elements. For example, they maybe functional elements of a computer.

The signal recognizing section 505 is connected to the inter-vehicle distance sensor 100 so that a detection signal from the inter-vehicle distance sensor 100 is input. The signal recognizing section 505 recognizes the value of a detection signal that is input from the inter-vehicle distance sensor 100 at computation cycles (e.g., at 20-millisecond cycles), and outputs the recognized value as a detection signal value L(n) at each computation cycle.

In the LPF 406, the first amplifier 401 is interposed between the delay element 403 and the adder circuit 404, while the second amplifier 402 is interposed between the signal recognizing section 505 and the adder circuit 404. The first amplifier 401 and second amplifier 402 multiply input signal values by respectively set filter coefficients c and d (where c+d=1, c>0, and d>0) and output the computed values. The filter coefficients c and d are set beforehand so that a very small change (noise) in the detection signal value L(n) can be sufficiently removed. Generally, the larger the filter coefficient c (the smaller the filter coefficient d), the higher the noise that can be removed. However, because the response delay to a change in the detection signal value L(n) becomes longer, the filter coefficients c and d are set to values such that noise can be reliably removed and, at the same time, the response delay to a change in the detection signal value L(n) does not become too long.

Note that the response delay used herein (i.e., the response delay considered in deciding the filter coefficients c and d) contains no response delay to an abrupt change in inter-vehicle distance due to the interruption or lane change of a preceding vehicle. This is because the response speed to such an abrupt change in inter-vehicle distance is assured by the inter-vehicle distance change judging section 506 or switch 507. Therefore, in the present invention, it is not necessary to take the interruption and lane change of a preceding vehicle into consideration, so more suitable coefficients can be set.

Signal values from the first and second amplifiers 401, 402 are input to the adder circuit 404, which adds and outputs the input signal values.

The delay element 403 is interposed between the switch 507 and the first amplifier 401 so that a signal value (i.e., an after-filtering signal value) input via the switch 507 is delayed and output by one computation cycle (20 milliseconds).

Therefore, the inter-vehicle distance information (detection signal) input from the inter-vehicle distance sensor 100 to the after-filtering inter-vehicle distance acquiring means 111 is first input to the signal recognizing section 505, in which the signal value is recognized at computation cycles of 20 milliseconds. The signal recognizing section 505 sends out the recognized signal value to the second amplifier 402, switch 507, and inter-vehicle distance change judging section 506, as the detection signal value L(n).

In the second embodiment, a pathway leading from the signal recognizing section 505 through the second amplifier 402 and adder circuit 404 and to the switch 507, that is, a pathway passing through the LPF 406 is called route 1. On the other hand, a pathway leading from the signal recognizing section 505 directly to the switch 507 without passing through the LPF 406 is called route 2.

In route 1, the second amplifier 402 multiplies the detection signal value L(n) from the signal recognizing section 505 by a filter coefficient d and sends out the computed signal value dL(n) to the adder circuit 404.

On the other hand, the after-filtering signal value F(n−1) in a computation cycle n−1 one before the current computation cycle n is input from the delay element 403 to the first amplifier 401. The first amplifier 401 multiplies the input after-filtering signal value F (n−1) by the filter coefficient c and sends out the computed signal value cF(n−1) to the adder circuit 404.

The adder circuit 404 adds the signal value cF(n−1) input from the first amplifier 401 and the signal value dL(n) input from the second amplifier 402 and outputs the added signal value cF(n−1)+dL(n).

That is, in the overall operation of route 1, the input detection signal value L(n) is converted into the following Eq. (1), and the signal value F(n) is output from the LPF 406.
F(n)=cF(n−1)+dL(n) (1)

In route 2, the detection value L(n) is output as it is. That is, it is output as the following Eq. (2) without being passed through the LPF 406.
F(n)=L(n) (2)

One end (output end) of the switch 507 is fixed, and by conducting current through a solenoid (not shown), the other end (input end) is connected with or disconnected from the terminals on the Y and N sides. The fixed output terminal (output end) outputs the after-filtering signal value F(n) as an output signal. The input terminal on the Y side is connected to the signal recognizing section 505 (i.e., route 2). The input terminal on the N side is connected to the adder circuit 404 of the LPF 406 (i.e., route 1).

The inter-vehicle distance change judging section 506 receives the detection signal value L(n) from the signal recognizing section 505. The input detection signal value L(n) is stored on the internal storage device of the inter-vehicle distance change judging section 506.

Furthermore, the inter-vehicle distance change judging section 506 computes a difference between the detection signal value L(n) in the current computation cycle n and the store detection signal value L(n−1) in a computation cycle n−1 one before the current computation cycle n, and compares the computed value with a predetermined value S. And the switch 507 is controlled as follows. That is, when the difference between the current detection signal value L(n) and the previous detection signal value L(n−1) is less than the predetermined value S (i.e., when a rate of change in the detection signal is small), it is judged that there is no abrupt change in inter-vehicle distance, and the switch 507 is connected to the terminal on the N side. On the other hand, when the above-mentioned difference is the predetermined value S or greater (i.e., when a rate of change in the detection signal is large), it is judged that there is an abrupt change in inter-vehicle distance, and the switch 507 is connected to the terminal on the Y side. Note that a variation in a signal value due to noise in the detection signal value L(n) is sufficiently smaller than a variation in a detection signal due to an abrupt change in inter-vehicle distance. Therefore, by setting the predetermined value S to a value midway between an amount of signal variation due to noise and an amount of signal variation due to an abrupt change in inter-vehicle distance, noise in the detection signal value L(n) can be prevented from being judged as an abrupt change in inter-vehicle distance.

Therefore, in the case where the switch 507 is being connected to the terminal on the N side (i.e., in the case of |L(n)−L(n−1)|≦ predetermined value S), the after-filtering signal value F(n) is output from the LPF 406 (route 1).

In the case where the switch 507 is being connected to the terminal on the Y side (i.e., in the case of |L(n)−L(n−1)|> predetermined value S), the after-filtering inter-vehicle distance F(n) is output from the LPF 406 (route 2).

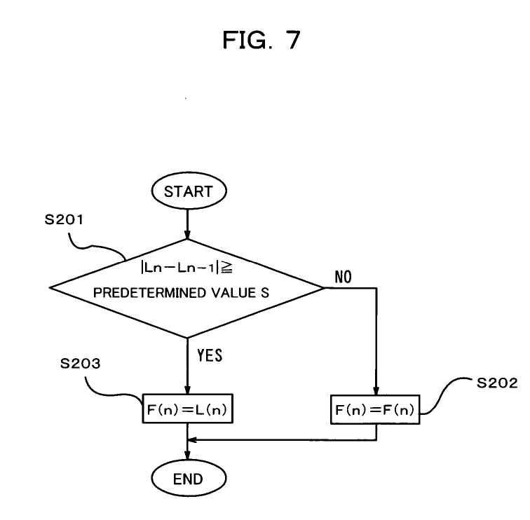

The relative speed computing apparatus according to the second embodiment of the present invention is constructed as described above. Therefore, as shown in FIG. 7, in step S201, the inter-vehicle distance change judging section 506 computes a difference between the current detection signal value L(n) and the detection signal value L(n−1) in a computation cycle n−1 one before the current computation cycle n. In the case where the computed difference is less than the predetermined value S, the inter-vehicle distance change judging section 506 judges that a rate of change in the inter-vehicle distance information (detection signal) detected by the inter-vehicle distance sensor 100 is small, and advances to step S202.

In step S201, in the case where the difference between the current detection signal value L(n) and the previous detection signal value L(n−1) is the predetermined value S or greater, the inter-vehicle distance change judging section 506 judges that a rate of change in the inter-vehicle distance information (detection signal) detected by the inter-vehicle distance sensor 100 is large, and advances to step S203.

Instep S202, the inter-vehicle distance change judging section 506 connects the switch 507 to the terminal on the N side. Therefore, the after-filtering signal value F(n), obtained by making a filtering computation (F(n)=cF(n−1)+dL(n)) on the basis of the current detection signal value Lr(n) and the previous detection signal value L(n−1), is output from the LPF 406 through the switch 507. At this time, c+d=1, c>0, and d>0.

Instep S203, the inter-vehicle distance change judging section 506 connects the switch 507 to the terminal on the Y side. Therefore, the detection signal value L(n) recognized by the signal recognizing section 505 is output through the switch 507 without undergoing the filtering computation.

Therefore, when there is no abrupt change in inter-vehicle distance, the above-mentioned filtering computation is performed on a detection signal output from the inter-vehicle distance sensor 100. That is, by adding the current detection signal value L(n) and the previous after-filtering signal value F(n−1) in a predetermined ratio to smooth a detection signal that changes finely, the after-filtering signal value F(n) can be made stable. Thus, noise can be suitably removed in the computation of a relative speed based on inter-vehicle distance information

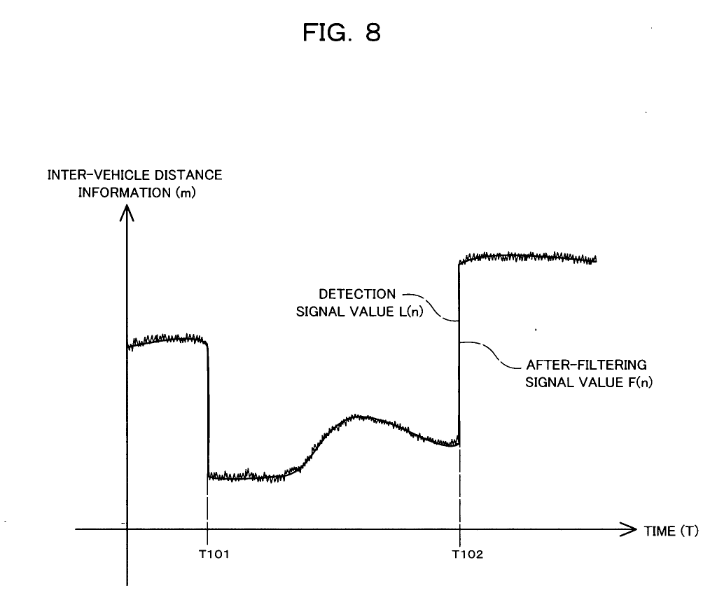

As shown in FIG. 8, in the computation cycle where an abrupt change in inter-vehicle distance occurs when inter-vehicle distance becomes short abruptly by the appearance of an interrupt vehicle at time T101 or when inter-vehicle distance becomes long abruptly by the disappearance of an interrupt vehicle at time T102, the detection signal value L(n) is output as it is. That is it is output as the after-filtering signal value F(n). Therefore, even when there is an abrupt change in inter-vehicle distance, relative speed can be computed without delay.

In this case, the detection signal value L(n) as it is, is set to the after-filtering signal value F(n) Therefore, in the case where the filtering computation is performed in each of the subsequent computation cycles, there is no influence of the after-filtering detection values obtained before an abrupt change in inter-vehicle distance. As a result, the after-filtering signal value F(n) that is to be computed becomes a value that is close to a detection signal value L(n) after an abrupt change in inter-vehicle distance. Accordingly, inter-vehicle distance can be output with good response while unwanted noise is being removed, and stable computations of relative speed can be performed.

What is claimed is:

1. A relative speed computing apparatus comprising:
inter-vehicle distance detecting means for detecting inter-vehicle distance information between a self-vehicle and other vehicle traveling in front or rear of said self-vehicle;
relative speed computing means for computing relative speed information between said self-vehicle and said other vehicle on the basis of said inter-vehicle distance information;
filter means for performing a filtering process on said relative speed information computed by said relative speed computing means; and
switch means switchable so that when a rate of change in a relative speed computation value computed by said relative speed computing means is a predetermined value or greater or when a rate of change in said after-filtering relative speed information filtered by said filter means is said predetermined value or greater, approximately zero is output as a relative speed, and so that when said rate of change in said relative speed computation value is less than said predetermined value or when said rate of change in said after-filtering relative speed information is less than said predetermined value, said after-filtering relative speed information is output as a relative speed;
wherein said relative speed is judged based on an output value of said switch means.

2. The relative speed computing apparatus as set forth in claim 1, wherein said filter means computes said relative speed computation value in a preset computation cycle and performs a filtering process which meets the following relation:
F(n)=aF(n−1)+bL(n)
where F(n) is first after-filtering relative speed information in a first computation cycle n, L(n) is a first relative speed computation value in the said first computation cycle n, F(n−1) is second after-filtering relative speed information in a second computation cycle (n−1) one before the first computation cycle n, a+b=1, a>0, and b>0.

3. The relative speed computing apparatus as set forth in claim 2, wherein
in a third computation cycle where said rate of change in said relative speed computation value computed by said relative speed computing means or said rate of change in said after-filtering relative speed information filtered by said filter means is said predetermined value or greater, said switch means sets said after-filtering relative speed information to zero; and
in each of the subsequent computation cycles after said third computation cycle, said filter means performs said filtering process based on said after-filtering relative speed information set to zero by said switch means.

4. The relative speed computing apparatus as set forth in claim 2, wherein said rate of change in said relative speed computation value is detected based on a difference between said first relative speed computation value L(n) obtained in said first computation cycle n by said relative speed computing means and a second relative speed computation value L(n−1) obtained in said second computation cycle n−1 by said relative speed computing means.

5. The relative speed computing apparatus as set forth in claim 1, further comprising:
inter-vehicle distance filter means for performing a filtering process on said inter-vehicle distance information detected by said inter-vehicle distance detecting means;
wherein said relative speed computing means computes said relative speed information based on the after-filtering inter-vehicle distance information filtered by said inter-vehicle distance filter means.

6. The relative speed computing apparatus as set forth in claim 1, where said inter-vehicle distance detecting means
performs a filtering process on an output value of an inter-vehicle distance sensor;
when a rate of change in said after-filtering output value filtered by said inter-vehicle distance detecting means is a predetermined value or greater, outputs the output value of said inter-vehicle distance sensor as said inter-vehicle distance information; and
when said rate of change in said after-filtering output value is less than said predetermined value, outputs said after-filtering output value as said inter-vehicle distance information.

7. An inter-vehicle distance control apparatus comprising:
acceleration-deceleration means for accelerating or decelerating a self-vehicle; and
acceleration-deceleration control means for actuating said acceleration-deceleration means based on an output value of the switch means of the relative speed computing apparatus as set forth in claim 1.

8. The inter-vehicle distance control apparatus as set forth in claim 7, further comprising:
vehicle speed detecting means for detecting a vehicle speed of said self-vehicle;
target inter-vehicle distance setting means for setting a target inter-vehicle distance between said self-vehicle and a preceding vehicle; and
target vehicle speed setting means for setting a target speed of said self-vehicle, based on said vehicle speed detected by said vehicle speed detecting means, said target inter-vehicle distance set by said target inter-vehicle distance setting means, and the output value of the switch means;
wherein said acceleration-deceleration control means accelerates or decelerates said self-vehicle according to said target speed.
